(19) United States
(12) Patent Application Publication
(10) Pub. No.: US 2003/0204551 A1
(43) Pub. Date: Oct. 30, 2003

(54) System and method for providing media processing services

(76) Inventor: Ling Chen, Livingston, NJ (US)

Correspondence Address: KENYON & KENYON, 1500 K STREET, N.W., SUITE 700, WASHINGTON, DC, 20005, US

(21) Appl. No.: 10/134,760

(22) Filed: Apr. 30, 2002

(51) Int. Cl. G06F 9/00

(52) U.S. Cl. 709/102

(57) ABSTRACT

A system for providing a plurality of media processing services includes a processor and a computer-readable medium. The computer-readable medium has stored thereon a set of instructions to be executed by the processor to control multiple media processing services as separate state machines, with the same set of instructions controlling each of the media processing services.

### TECHNICAL FIELD

Embodiments discussed below relate to an architecture for using a digital signal processor to provide multiple media processing services.

### BACKGROUND

Digital signal processing refers to manipulation of signals by a processor. These signals typically represent analog information from the real world, such as a representation of a sound or an image, that has been converted into a digital form. For example, when a voice is spoken into a receiver in a handset of a telephone unit, the voice information may be converted into digital form and the digital information may then be transmitted and manipulated by the telephone system. In the telecommunications field, digital signal processing is performed by devices such as telephones and voice mail systems to provide services such as an audio player, an audio recorder, a signal detector, etc. Many other fields also employ digital signal processing, such as medical devices for diagnostic imaging, devices for data, image, or sound compression, and devices for simulation and modeling.

A processor that performs digital signal processing may be referred to as a digital signal processor. In many cases, a digital signal processor performs multiple digital signal processing services for a large number of signal sources simultaneously. Each service may represent a set of features. For example, a digital signal processor in a telecommunications system may provide services like audio player, audio recorder, and signal detector for a larger number of channels (e.g., telephone lines) at the same time. Each service that is provided by a digital signal processor may be referred to as a “media processing resource” or “media processing service.” Each channel may be serviced by an instance of a media processing service. Thus, for example, a first channel may be serviced by a first instance of an audio player, a second channel may be serviced by a second instance of an audio player, a third a second channel may be serviced by a first instance of a signal detector, etc.

In additional to the signals being processed by the digital signal processor, which may be referred to as “media data,” a digital signal processor may also receive commands that are used to control how the media data is processed, which along with control-related system messages may be referred to as “control messages.” For example, a digital signal processor may receive control messages that request the initiation of an audio player service for a channel (e.g., telephone line no. 2) or the termination of an audio recorder service being provided for another channel (e.g., telephone line no. 10). Once a media processing service is initiated for a channel, the digital signal processor will process media data for that channel to carry out that service. Because at any given time the digital signal processor is performing multiple media processing services, the digital signal processor must share its resources (e.g., processor cycles, memory space, I/O devices, etc.) among the different services being performed.

### DESCRIPTION OF THE DRAWINGS

FIG. 1 is a block diagram of a media processing system including a set of stored instructions to control a plurality of media processing services as state machines according to an embodiment.

FIG. 2 is an operational diagram that shows the operation of a media processing system according to an embodiment.

FIG. 3 is a state diagram that shows an example of states and state transitions for a media processing service according to an embodiment.

FIG. 4 is a block diagram of a media processing system that shows tables and instructions used to provide media processing services according to an embodiment.

FIG. 5 is a block diagram of a control description table and job scheduler table according to an embodiment.

FIG. 6 is a flow diagram that shows a method of controlling a plurality of media processing services according to an embodiment.

FIG. 7 is a flow diagram that shows a method of managing the execution of digital signal algorithms for a plurality of media processing services according to an embodiment.

### DETAILED DESCRIPTION

Embodiments provide an architecture for a high-density media processing system. In embodiments, media processing services are integrated to improve use of processor resources by implementing the control logic for the media processing services as a generic state machine. A generic state machine uses a common engine to implement multiple state machines, each of which stores its status and operates on input to change the status and/or cause an action to take place. In embodiments, the generic state machine is implemented by a low priority control task (or thread) that is provided by a multitasking operating system to performs control logic and manage state transitions for multiple instances of each media processing service. This control task may place media processing jobs on queues in response to the control data, and a plurality job execution tasks may invoke digital signal algorithms to process the media data according to the jobs that are listed on the queues. In embodiments, the processing of media data may be performed in a different execution environment than the processing of control messages and the resources (e.g., processor cycles, locations in a memory) may be shared between the media processing services to improve resources usage.

According to an embodiment, a system for providing a plurality of media processing services includes a computer-readable medium that has stored thereon a set of instructions to be executed by the processor to control a plurality of instances of a plurality of media processing services as a plurality of state machines. In an embodiment, the design of the media processing system is modularized so that each media processing service is defined by a distinct data/code structure, and a new media processing service may be added to the media processing system by adding a data/code structure to implement that media processing service. According to an embodiment, a media processing service must be designed to interface with the generic state machine engine, but the design of a new media processing service may be otherwise done independently of other media processing services. In embodiments, the system includes a table (which may be referred to as a control description table) that is stored on the computer-readable medium for each of the media processing services provided by the system, and each of these tables may define the functioning of the associated media processing service. Each table may contain information relating to the operation of state machines for that media processing service and may define the operation of the state machine for that media processing service. In a further embodiment, a control description table for a media processing service may have an entry for each state, and each entry may contain instructions to initialize that state and to process control messages for that state.

In an embodiment, multiple instances of media processing functions are created when the media processing system is booted-up. A run-time data object may be created which contains an entry for each channel that is provided by the media processing system. In an embodiment, each entry in this run-time data object may identify the media processing service that is being provided for that channel and the current state of that media processing service. A control task may then be executed to control the state machine for each media processing service. For example, the same instruction module (e.g., generic state machine control instructions) may be executed to implement the generic state machine. Each instance of a media processing function may be implemented as a different state machine.

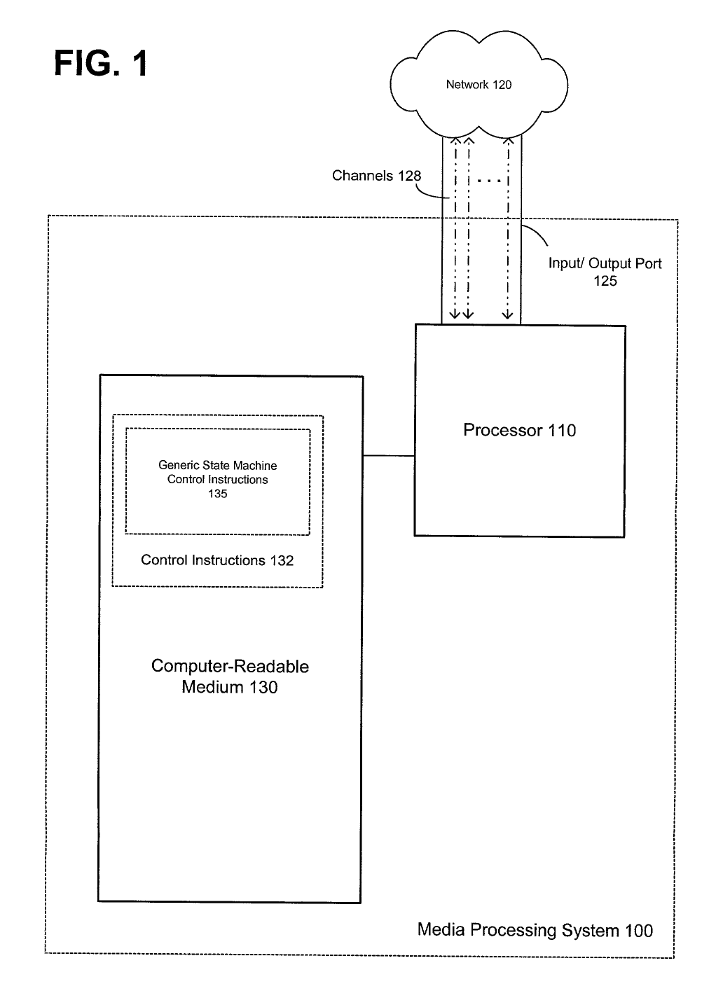

FIG. 1 is a block diagram of a media processing system 100 that includes a set of stored instructions to control a plurality of media processing services as state machines according to an embodiment. Media processing system 100 may be, for example, a circuit that is inserted into a slot of a computer system chassis. Media processing system 100 may also be a stand-alone system or may be part of any other device. As shown in FIG. 1, the media processing system includes a processor 110 that is coupled to a computer-readable medium 130. The term coupled is intended to encompass elements that are directly connected or indirectly connected. Processor 110 may be a general purpose microprocessor, a digital signal processor, a micro-controller, or other type of processing unit. Computer-readable medium 130 may be may any type of medium capable of storing instructions, such for example a random-access memory (RAM) or a flash memory.

As shown in FIG. 1, computer-readable medium 130 stores control instructions 132 that include generic state machine control instructions 135. The instructions may be, for example, software instructions, firmware instructions, microcode, or any other type of instructions that may be executed by the processor. In an embodiment, generic state machine control instructions 135 process command information and determine state transitions or other actions to be taken for each state of instances of multiple media processing services. Of course, the computer-readable medium 130 may also store additional instructions, and the media processing system may contain additional computer readable mediums.

Media processing system 100 has an input/output port 125 that is coupled to a network 120. Input/output port 125 and network 120 may be, for example, a trunk connection that contains a group of telephone channels, a network card that is coupled to an Internet or a private network, etc. The media processing system may also be coupled to receive input from a source other than a network. As shown in FIG. 1, a plurality of information channels 128 may be communicated to the media processing system simultaneously. For example, the media processing system may simultaneously process media data for a number (e.g., hundreds) of different telephone lines. Of course, the different information channels may be communicated in serial form (e.g., packets) so that the data for each channel need not be transmitted to the media processing device at the same exact time even though the channels are, from a real-time perspective, processed simultaneously. As discussed below, media processing system 100 may process received command information and media data to simultaneously provide multiple media processing services for multiple channels.

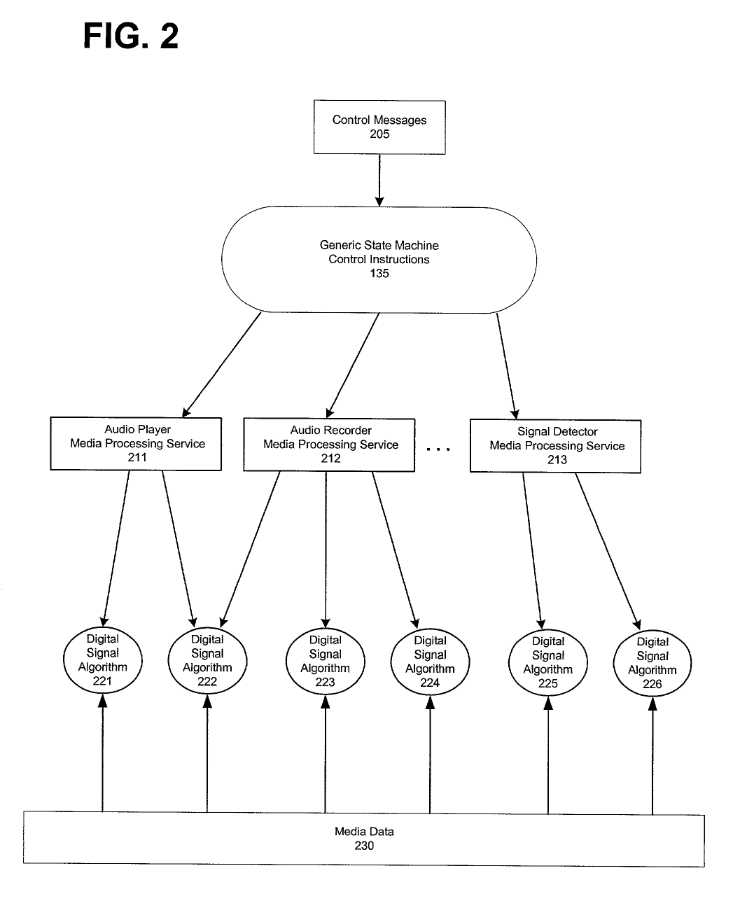

FIG. 2 is a operational diagram that shows the operation of a media processing system according to an embodiment. FIG. 2 shows a media processing system's control instructions 132 and generic state machine control instructions 135, media processing services (211-213), and digital signal algorithms (221-226). The media processing system whose operation is illustrated in FIG. 2 may receive control messages 205 and media data 230 through input/output port 125 as discussed above. In addition to control messages received from an external source, the media processing system may also receive control messages in the form of messages generated by the system (e.g., event information). The control messages may be processed by the control instructions 132 and generic state machine control instructions 135, which controls the operation of the media processing services (211-213). The media processing services each cause a set of digital signal algorithms (221-226) to process the media data. The digital signal algorithms may be implemented by instructions that are, for example, stored on computer-readable medium 130 and executed by processor 100 of FIG. 1. Two different media processing services may invoke the same algorithm(s), such as for example media processing services 211 and 212 which both invoke algorithm 222.

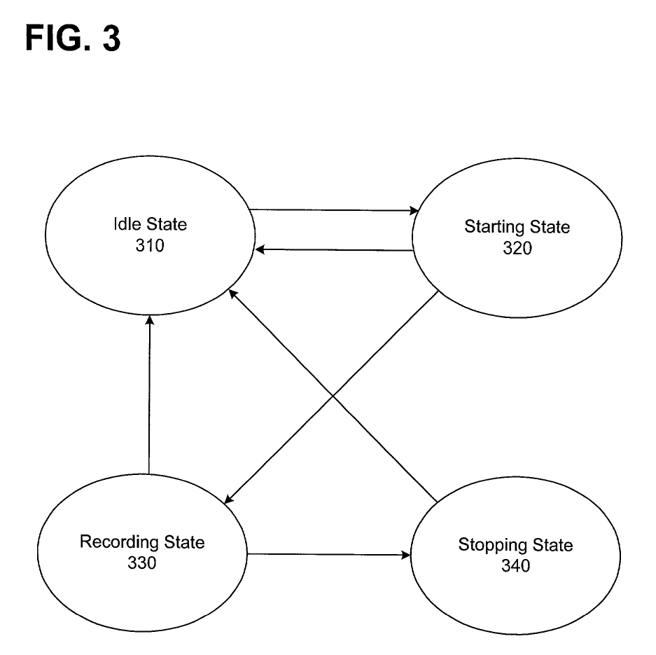

In an embodiment, the control instructions 132 and generic state machine control instructions 135 include instructions that implement a generic state machine to process control messages and control the operation (i.e., provide the control logic) for the media processing services that are provided by the media processing system 100. In this embodiment, the same set of control instructions may process control messages for a plurality of state machines that are provided by the media processing system. An example of the operation of a state machine is discussed with reference to FIG. 3. The control instructions 132 of FIG. 1 may perform other operations such as command interpretation and dispatch and error handling for the various media processing resources. The control instructions 132 and generic state machine control instructions 135 may define the formats and model how the control logic of the media processing services are implemented so that a single generic state machine may act as the control mechanism to perform the control logic for all of the media processing services (MPSs) that are provided by media processing system 100.

FIG. 2 shows an audio player MPS 211, an audio recorder MPS 212, and a signal detector MPS 213. These are just examples of media processing services, and a media processing system may include additional or different services. Audio recorder MPS 212 may convert an audio stream received on a particular channel (i.e., part of the media data 230 received by the system) to a compressed format and may store the compressed data. In particular, the generic state machine control instructions 135 may receive command information requesting that the media processing system begin recording audio data received over a particular channel, and generic state machine control instructions 135 may then invoke the control logic of audio recorder MPS 212 to cause the audio recorder to enter the recording state. While in the recording state, the audio recorder MPS may invoke a job that uses a data compression algorithm (e.g., 222) and a data storage algorithm (e.g., 223) to store the media data received on the channel indicated. The audio recorder MPS may also invoke other digital signal algorithms such as an automatic gain control algorithm (e.g., 224) and a silence compression algorithm. Although FIG. 2 shows the media data being processed by each algorithm directly, the data may be transmitted from one algorithm to the next. Thus, the digital signal algorithms perform the basic job services for the media processing system. Other examples of digital signal algorithms are audio encoding and decoding, signal detection (e.g., detecting variable types of phone/fax/modem tones), echo cancellation, signal generation, active voice detection (VAD), audio conference, etc.

During operation of the media processing system there may be multiple instances of each media processing service operating at any given time. For example, at a given time there may be one instance of audio recorder MPS 212 that is in playing media data for one channel, another instance of audio recorder MPS 212 that is in playing media data for a second channel, another instance of audio recorder MPS 212 for a third channel that is the stopping state, another instance of audio recorder MPS 212 for a fourth channel that is the idle state, etc. At the same time, multiple instances of other media processing services (e.g., 211 and 213) may also be operating.

The media processing services shown in FIG. 2 may be implemented by the operation of a generic state machine control task, each of which may execute generic state machine control instructions, and job execution tasks, which may manage the execution of the digital signal algorithms during the operation of the media processing system. For example, the control task for the audio recorder MPS 212 may initiate the recording of media data by indicating to the appropriate job execution tasks that the required digital signal algorithms (e.g., 222, 223, and 224) should be executed on new media data (until the control task determines that recording should stop). In this example, the appropriate job execution tasks may then invoke the appropriate digital signal algorithms as desired. For example, the job execution task corresponding to the data compression algorithm may invoke the data compression algorithm at intervals so that new media data that has been received for a channel being recorded may be compressed, the job execution task corresponding to the data storage algorithm may invoke the data storage algorithm at intervals so that the compressed media data may be stored, etc.

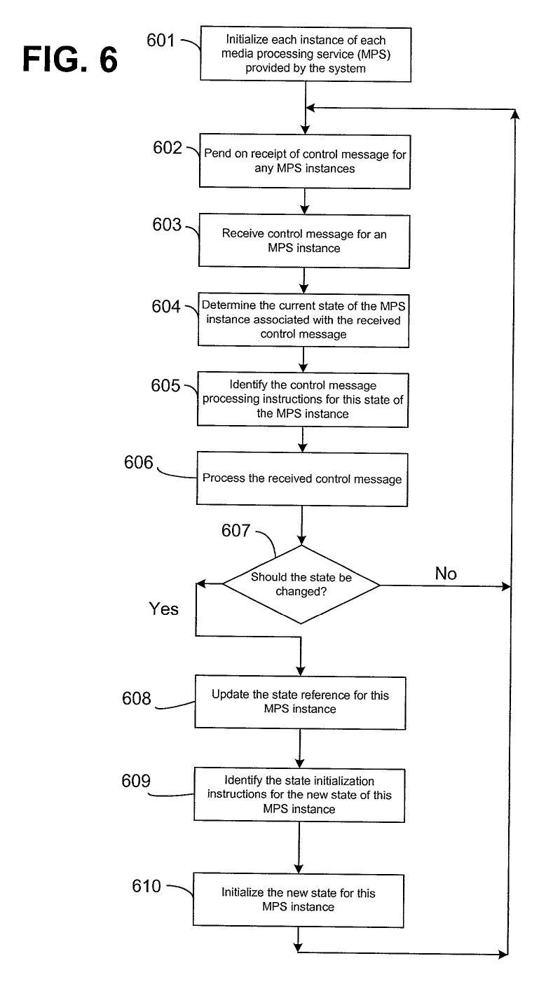

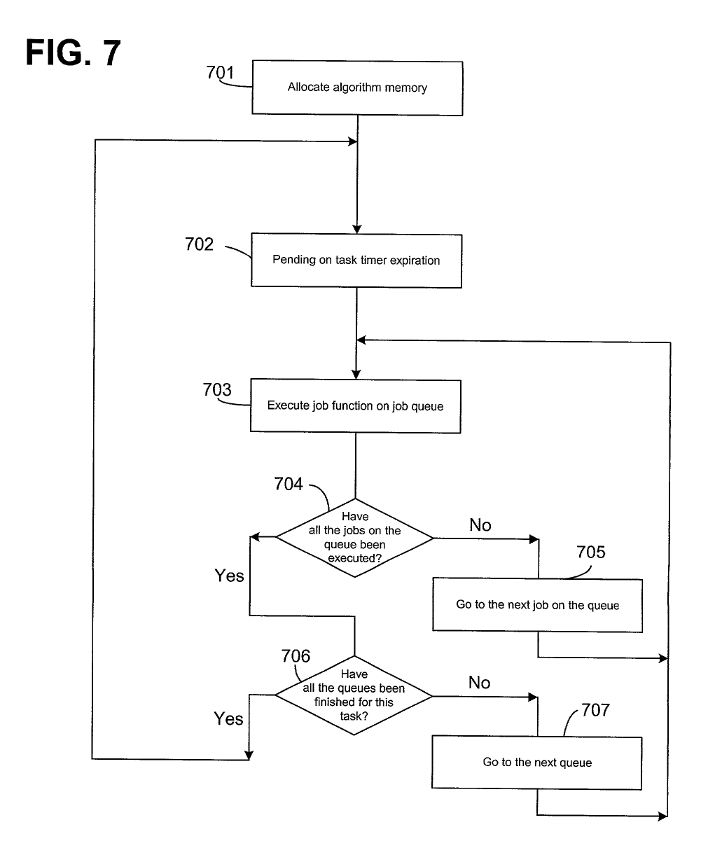

In an embodiment, the processor in the media processing system has the ability to multitask (i.e., execute more than one set of instructions, and more than one instance of the same set of instructions, in real-time). According to an embodiment, during operation processor 100 executes a control task as well as multiple job execution tasks. The control task may process control data, while the job execution tasks may manage the processing of media data. Thus, the media data and the control messages are processed in separate execution environments. The operation of the control task and the execution tasks is described below with reference to FIGS. 6 and 7.

FIG. 3 is a state diagram that shows an example of states and state transitions for a MPS according to an embodiment. For example, FIG. 3 may show the states and state transitions for an instance of audio recorder MPS 212 of FIG. 2. As show in FIG. 2, the MPS has four states: the idle state (310), the starting state (320), the recording state (330), and the stopping state (340). According to this example, an instance of audio recorder MPS 212 may initially be in the idle state, in which case it may be waiting for a command to perform audio recording. If the generic state machine control instructions 135 (i.e., the generic state engine) receive a command requesting that audio recording be initiated for the channel associated with this instance of the audio recorder, then the generic state machine control instructions 135 execute the control logic associated with the idle state of the audio recorder MPS 212, which may cause this the state machine for this instance of the audio recorder to transition to the starting state (320). This instance of the audio recorder MPS may then wait in the starting state until the generic state machine control instructions receive new control messages.

For example, the generic state machine control instructions 135 may receive command information indicating that the user has requested that the audio recorder be stopped or may receive a system message indicating that there was an input/output (I/O) error, in which case it may execute the control logic associated with the recording state that causes this instance of the audio recorder MPS to transition back to the idle state (310). As another example, the generic state machine control instructions 135 may receive control messages in the form of a system message indicating that system I/O is ready, in which case it may cause this instance of the audio recorder MPS to transition to the recording state (330). Similarly, while in the recording state the generic state machine control instructions 135 may receive control messages indicating that the user has requested that the audio recorder be stopped or may receive a system message indicating that the end of data has been reached, in which case it may cause this instance of the audio recorder MPS to transition to the stopping state (340). While in the recording state, the generic state machine control instructions 135 may also receive a system message indicating that there was an I/O error, in which case it may cause this instance of the audio recorder MPS to transition back to the idle state (310). Finally, in the stopping state the generic state machine control instructions 135 may receive a system message indicating that the I/O has stopped or that there was an I/O error, in which case it may cause this instance of the audio recorder MPS to transition back to the idle state (310).

In embodiments, each MPS that is being provided by the media processing system has a state machine that transitions through states such as shown in FIG. 3. Of course, other media MPS may have different states and may include more or less states than shown in FIG. 3, and in other embodiments an audio recorder may include different states than shown. In an embodiment, the states for a particular MPS may be defined by the designer of a particular MPS (as opposed to the designer of the overall media processing system) and may be described by a control description table as discussed below.

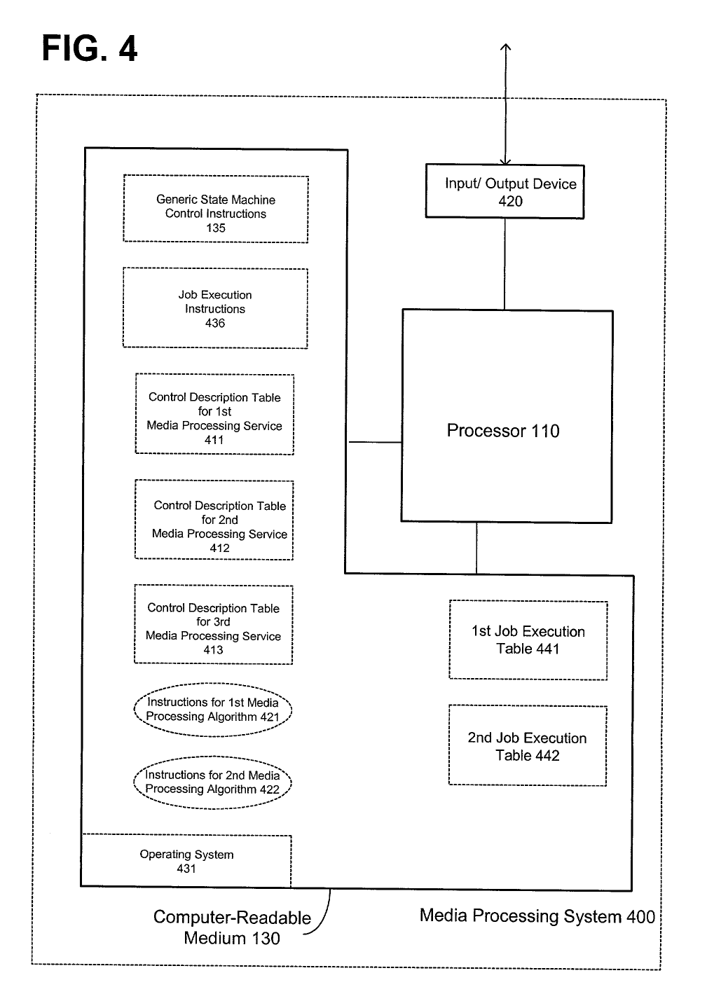

FIG. 4 is a block diagram of a media processing system that shows tables and instructions used to provide media processing services according to an embodiment. FIG. 4 shows a processor 110 and computer-readable medium 130 such as shown in FIG. 1. In addition, FIG. 4 shows an input/output device 420 which may any type of input/output device that may be used by media processing system 400 and may be shared by the different media processing services. As shown in FIG. 4, computer-readable medium 130 stores a number of sets of instructions and tables. Each set of instructions may be, for example, a module or a number of modules. In particular, computer-readable medium 130 stores generic state machine control instructions 135 (as in FIG. 1), job execution instructions 436, instructions for a first media processing algorithm 421, instructions for a second media processing algorithm 422, and operating system 431. In an embodiment, the same set of job execution instructions may manage the processing of media data, as show for example in FIG. 7. The instructions for a first media processing algorithm 421 may correspond for example to the instructions for media processing algorithm 221 of FIG. 2, and the instructions for a second media processing algorithm 422 may correspond for example to the instructions for media processing algorithm 222 of FIG. 2. Operating system 431 may be the instructions for an operating system that is executed by processor 110 and controls the execution of tasks by processor 110 (e.g., switches between tasks).

Computer-readable medium 130 is shown in FIG. 4 as also storing three control description tables. In particular, computer-readable medium 130 is shown storing a control description table for a first media processing service 411, a control description table for a second media processing service 412, and a control description table for a third media processing service 413, each of which may be used by a different media processing service as described below. The control description table for a first media processing service 411 may implement, for example, an audio player media processing service 211 of FIG. 2, the control description table for a second media processing service 412 may implement audio recorder media processing service 212 of FIG. 2, etc. Computer readable-medium 130 is also shown storing a first job execution table 441 and a second job execution table 442 which each may correspond to a job execution task that is being executed by the media processing system (such as a first job execution task and second job execution task). Of course, computer-readable medium 130 may store information in addition to the instruction sets and tables shown.

In an embodiment, the instructions and tables shown in computer-readable medium 130 of FIG. 4 are stored on another non-volatile computer-readable medium (such as a flash memory) on a static basis for the life of media processing system 400, and at when the media processing system 400 is booted up the tables and instructions are copied to a volatile memory (such as an SRAM). In an embodiment, the job execution tables may be the only tables of those shown that are updated on a dynamic basis during the operation of media processing system 400, but all the tables may be copied to a volatile memory because the volatile memory may have a faster access time.

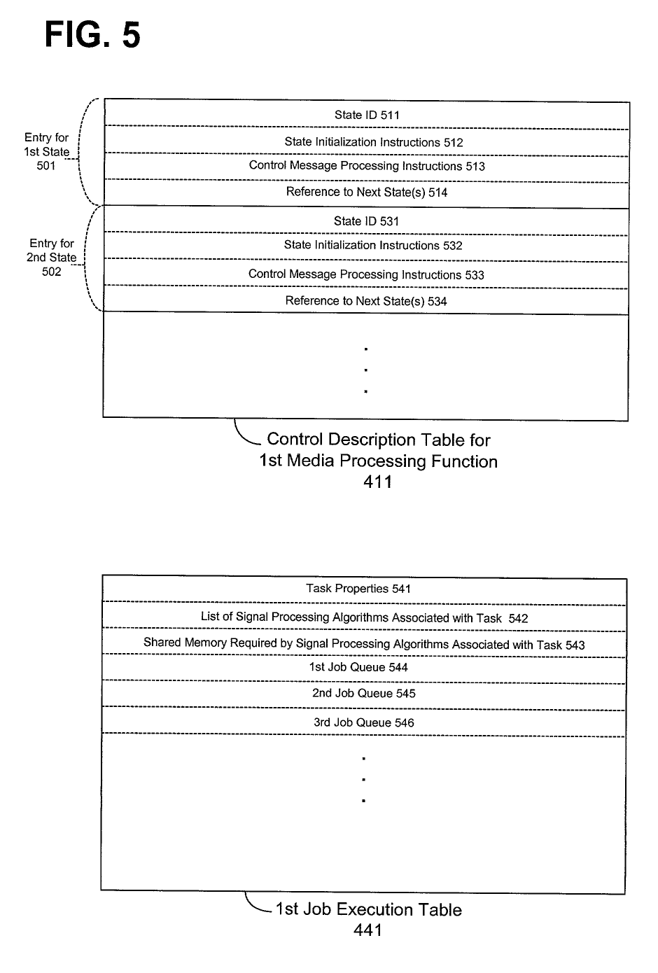

FIG. 5 is a block diagram of a control description table and job execution table according to an embodiment. FIG. 5 shows further details of control description table 411 and first job execution table 441 of FIG. 4. In an embodiment, control description table 411 corresponds to a single media processing service that may be performed by the media processing system (such as for example audio recorder MPS 212). Control description table 411 has a plurality of entries each of which correspond to a state (such as an entry for the idle state 310, an entry for the starting state 320, an entry for the recording state 330, and an entry for the stopping state 340). FIG. 5 shows control description table having an entry for a first state 501 and an entry for a second state 502, but of course control description table 411 may have more or less entries than is shown. Each entry in control description table 411 has fields for a state ID (511 and 531), state initialization instructions (512 and 532), control messages processing instructions (513 and 533), and a reference to the next state or states (514 and 534). The state ID field may contain information such as state name (e.g., the “stopping” state) and other information that may be used for debugging purposes. The state initialization instructions and control messages processing instructions in each entry of the table may be actual instructions or a reference (i.e., pointer) to a set of instructions that perform state initiation and process control messages for the state of the corresponding media processing service. In both cases, the entry may be said to “contain” or “include” the instructions. The reference to the next state may be a pointer to states that may follow. For example, the reference to state field 514 for the recording state 330 of an audio recording service may include a pointer to the idle state 310 and a pointer to the stopping state 340.

FIG. 5 also shows first job execution table 441 which may correspond to first job execution task. First job execution table 441 includes a field for task properties 541, a list of digital signal algorithms associated with the task 542, information regarding the shared memory requirements of the digital signal algorithms associated with the task 543, and three job queues (544-546). The task properties may include, for example, a name of the task, a priority for the task, and an execution interval (i.e., a period for the execution timer) for the task. In embodiments, execution intervals for processing tasks to be performed (and the associated digital signal algorithms) may have different duration and/or processing tasks may have different priorities. For example, one algorithm may require that a frame of data be processed every 10 milliseconds (ms), another algorithm may require that a frame of data be processed every 30 ms, etc. In an embodiment in which the job execution table has multiple job queues, these queues may be used to control the order of execution of the jobs. For example, the job queues may be used to group execution of jobs so that the same type of job is executed together. The digital signal algorithms associated with a task may be, for example, the digital signal algorithms 224 and 225 of FIG. 2. The list of digital signal algorithms associated with the task 542 and the information regarding the shared memory requirements of the digital signal algorithms associated with the task 543 may be used to allocate resources to the task as discussed below. In embodiments, each algorithm that is associated with a task is also associated with one or more job queues. In embodiments, the job queues are dynamic. First job execution table 441 may be used by a job execution task to manage the processing of media data as discussed in more detail below. Job execution tables and queues may provide for the grouping of digital signal algorithms so that those with the same execution interval (e.g., 30 ms) may be run together. Of course, control description table 411 and first job execution table 441 may include more, less, or different entries than shown in this embodiment.

FIG. 6 shows a method of controlling a plurality of media processing services according to an embodiment. The methods shown in FIG. 6 will be discussed with reference to the media processing systems shown above in FIGS. 1-5, but of course this method (and the method shown in FIG. 7) may also be used with other media processing systems. FIG. 6 shows an example of the operation of a control task, and in other embodiments a control task may perform more, less, or different operations. Prior to (or at the start of) the execution of the control task, each instance of the media processing service that is to be provided by the system is initialized (601). That is, a run-time object may be created that indicates for each channel which media processing service is being provided and what the state is of that instance of the media processing service.

The control task will then pend on receipt of a control message by the media processing system (602). In an embodiment, when a control message is received (603), the operating system may wake-up the control task. The received control message will relate to a particular instance of a particular media processing service. For example, the control message may be a request to start audio recording for a particular channel (e.g., channel 10). The control task may then determine the current state for that instance of the media processing service (604). For example, the control task may determine that the media player for channel 10 is in the idle state. The control task may then identify the control processing instructions for this instance of the media processing system (605). The control task may identify the control message processing instructions 513 in control description table 411 as the instructions to process the received control message (for example if the control description table 411 corresponds to the media recorder and the first entry 501 is the entry for the idle state). The control task may then process the received control message by executing the instructions that were identified (606). For example, the control task may execute the instructions 513, which may process control information according to the requirements of the idle state 310 of FIG. 3. Thus, for example, if the control message received is a request to start audio recording for this channel, and the state machine for the audio recorder for this channel is in the idle state, then the instructions 513 may determine that the state should be changed to the starting state 320. In another example, the control message received is another type of message (such as an error message) that is processed by the instructions 513.

If it was determined (e.g., by the control message processing instructions) that the state should be not changed (607), then the control task will again pend on receipt of a control message for any media processing service instance. The next control message may be for a different instance of the same media processing service of for a different media processing service. Control messages may be queued waiting for the control task to finish processing the last message, or the control task may have to pend until a new control message is received. In embodiments, control messages do not have to be processed in real time, and thus may wait for the control task.

If it was determined that the state should be changed (607), then the control message will update the state reference, such as may be stored in a real time data object, for this instance of the media processing service to the new state (608). The control task may then identify the state initialization instructions for the new state of this media processing service (609) and may then execute those instructions to initialize the new state for this instance of the media processing service (610). For example, the control task may initialize a new state by invoking the instructions in the entry of the control description table for that MPS that corresponds to the new state (e.g., in entry 532 of FIG. 5). Initializing the new state may include, for example, adding a job or deleting a job from a queue, starting or stopping an I/O device, allocating or freeing memory, etc. Thus, entry 532 may include instructions to add a job to a job queue.

For example, if (1) the control task is executed for the audio recorder, (2) the state machine for this instance of the audio recorder is in the starting state (320), and (3) command information is received indicating that I/O is ready, then the control message processing instructions 513 may be invoked and may determine that the state for this MPS should be changed to the recording state (330). The instructions in entry 532 may be called to initialize the recording state, which may include submitting one or more jobs to the job queues on job execution tables (e.g., 441 and 442 of FIG. 4) that are associated with the digital signal algorithms that need to be performed to carry out the processing of media data for the audio recording service. Thus, the control instructions use job execution tables to manage the processing of jobs. The execution of the jobs that were submitted to the job queues may be performed by job execution tasks according to the method discussed with reference to FIG. 7. A job may stay listed on the appropriate job queues until the control instructions remove the job from the job queue (e.g., when that instance of the media processing resource enters the stopping state).

FIG. 7 is a flow diagram that shows a method of scheduling the processing of media data for a plurality of media processing services according to an embodiment. The method shown in FIG. 7 may be performed by job execution instructions 436. In an embodiment, a number of job execution tasks may each execute job execution instructions 436 to simultaneously perform the method shown in FIG. 7. In an embodiment, the job execution task may be performed simultaneous with, and in a separate execution environment than, the control task discussed above. According to the embodiment shown in FIG. 7, a job execution task starts by allocating memory for a set of digital signal algorithms that are associated with the job execution task (701). For example, a media processing service may use or be associated with more or more job queues and may create one or more jobs for each instance of the media processing service. In addition, a particular job execution task may have one or more job queues, and each job queue may be associated with one or more algorithms. A job execution task may be associated with a table such as first job execution table 441, and the algorithms associated or registered with the task may be listed in an entry of the job execution table (542). Allocation of memory for the job execution task may involve requesting locations in a memory (e.g., in computer-readable medium 130) which may accommodate the maximum scratch memory requirements for the digital signal algorithms registered with this task. Scratch memory is memory that is used temporarily by a digital signal algorithms while that algorithm is being executed but may be relinquished when the algorithm is completed.

According to this embodiment, the job execution task may then pend for a task timer to expire (702). Each task may have an execution interval which may be stored in the job execution table for that task (e.g., in entry 541). The task may be pending on a timer maintained by the operating system. Once the task timer has expired, the job execution task may execute a job (if any) that is on one of the job queues for that task (703). The job execution task may execute a job by causing the digital signal algorithm associated with that queue to be executed. If all of the jobs on that job queue have not been executed (704), the job execution task may go to the next job on that queue (705) and cause that next job to be executed (703). Once all of the jobs on that job queue have been executed, the job execution task may determine if it has finished all of the queues for that task (706). If all of the queues are not finished, the job execution task may go to the next queue (707) and execute the jobs on that queue (703-705). Once all of the queues for a task have been finished, the job execution task will wait for the task timer to again expire (702).

For example, the control task may have submitted jobs for an audio recorder MPS to the appropriate queue(s), and these jobs may cause the execution of algorithms such as a data compression algorithm, a data storage algorithm, and a silence compression algorithm. In an embodiment, the data compression algorithm and data storage algorithm are both associated with the same control task and are executed on the same time schedule and with the same priority. Different jobs that are associated with a particular job execution task may be executed with the same or different priorities and have the same or different execution periods. When the first job execution task's execution timer expires, it may cause the execution of the jobs on the queues associated with first job execution table 441. Similarly, when the second job execution task's execution timer expires (which in this example may be less frequently then the first control task's execution timer), the second job execution task may cause the execution of the jobs on the queues associated with second job execution table 442. There may be multiple instances of the same media processing service running at any given time (e.g., for different channels), and there may be multiple jobs submitted for an algorithm for a single class of media processing service (although the jobs may be assigned to process data for different channels). The job execution tasks may be preformed simultaneously (from a multitasking perspective) with the control task.

An embodiment provides for the allocation and sharing of memory for different digital signal algorithms and their instances by the media processing system. Such digital signal algorithms may require scratch memory, constant-data memory, and persistent memory. Constant memory may store information, such as a table, that does not change during the operation of the system. Persistent memory may be used during the operation of a particular instance of an instance of a media processing resource (e.g., may be used thought the life of an audio player for a particular channel). Scratch and constant-data memory may be allocated from a processor's internal memory pool. In an embodiment, constant-data memory contains data (e.g., a table) that maintains a constant value during operation of the media processing system. In an embodiment, scratch memory and constant-data memory may be set up when a new job execution task is created (e.g., as shown in 701 of FIG. 7). Management instructions may determine the memory requirements of all the digital signal algorithms registered with that task (e.g., from entry 543 of first job execution table 441), may determine the maximum requirement of scratch memory among all the digital signal algorithms registered with the task, and may allocate a shared scratch memory block from processor's internal memory pool. The job execution task may then acquire the requirements of constant-data memory for each of the digital signal algorithms registered with the task and may allocate constant-data memory locations (e.g., from a processor's internal memory pool).

In an embodiment, persistent memory must be allocated for each algorithm's instance through the instance's life cycle. Persistent memory may be allocated and freed during the creation of an algorithm's instance such as, for example, when the control message processing instructions 413 for the recording state of an instance of the audio recorder MPS adds a job to a job queue (e.g., when initializing a new MPS instance as shown in 601 of FIG. 6). In an embodiment, the control message processing instructions acquire the persistent memory requirements for an digital signal algorithms being added to the job queue and may allocate a block of persistent memory for this instance of the algorithm. The control message processing instructions may also obtain information on the scratch and constant-data memory that was pre-allocated for this algorithm and may pass the information of all three types memory to the instance via the algorithm's interface. In this example, the control message processing instructions may perform instance initialization via an algorithm's interface, and this the instance may be used to complete a media processing job. When the media processing job is completed, such as for example when the audio recorder MPS goes to the stopping state, the control message processing instructions (e.g., 533 of FIG. 5) may retrieve the memory information for this instance of the algorithm, may free the persistent memory, and may delete this instance of the algorithm.

In an embodiment, a designer of a media processing service (e.g., of an audio recorder) may develop a control description table for this media processing service which may be added to a media processing system to incorporate this media processing service into the system. According to embodiments, individual media processing services are substantially independent components of the media processing system. Thus, embodiments may be used to improve the process of designing a media processing system. Several embodiments are specifically illustrated and/or described herein. However, it will be appreciated that modifications and variations are covered by the above teachings and within the purview of the appended claims without departing from the spirit and intended scope.

What is claimed is:

1. An apparatus comprising a computer-readable medium having stored thereon a first set of instructions to be executed by a processor to control a plurality of media processing services as a plurality of state machines, wherein the same first set of instructions control the state machine for each of the media processing services.

2. The apparatus of claim 1, wherein the computer-readable medium also stores a plurality of tables each of which relates to the operation of the state machine for a different media processing service, wherein each table comprises a plurality of entries, and wherein there is one entry for each of the media processing service's states.

3. The apparatus of claim 2, wherein each of said entries includes a second set of instructions to initialize the state corresponding to that entry, and wherein each of said entries also includes a third set of instructions to process control messages for the state corresponding to that entry.

4. The apparatus of claim 3, wherein the third set of instructions include instructions to add a job to one of a plurality of queues, and wherein the computer-readable medium also has stored thereon a fourth set of instructions to manage the processing of media data for the plurality of media processing services by causing the execution by the processor of algorithms based on the jobs that are listed on said queues.

5. The apparatus of claim 4, wherein the first set of instructions and the fourth set of instructions are to be executed by the processor as separate tasks.

6. The apparatus of claim 4, wherein the fourth set of instructions are to be executed by the processor as a plurality of tasks, and wherein each of said queues is associated with one of said tasks.

7. The apparatus of claim 6, wherein each job is implemented by one or more algorithms, and wherein the fourth set of instructions allocate memory locations in a memory at the start of each of said tasks to accommodate a maximum scratch memory requirement for the algorithms that implement jobs associated with that task.

8. A method of providing a plurality of media processing services, the method comprising:
receiving control messages relating to instances of a plurality of media processing services; and
executing a control task to process received control messages for each of the media processing services, wherein the control task performs a method that comprises:
determining the current state of the instance of the media processing service to which a received control message relates;
processing the control message as appropriate for the current state of said instance; and
initializing a new state for said instance if during processing of the control message it is determined that the state should be changed.

9. The method of claim 8, wherein each of the plurality of media processing services is associated with a different table, wherein each table has an entry for each state for that media processing service, and wherein processing of the control message and initializing a new state are performed by executing instructions contained in the entry for the current state.

10. The method of claim 9, wherein the table includes instructions to add a job to one of a plurality of queues, and wherein the method of performing a plurality of media processing services further comprises:
creating a plurality of tasks to be executed by the processor to process media data, wherein each of the queues is associated with a task;
allocating scratch memory for each of the processing tasks; and
performing repeatedly for each task a same set of processing instructions that includes instructions to:
wait for a task timer for the task to expire; and
process media data according to the jobs listed on any queues associated with the task.

11. The method of claim 10, wherein task timers for at least two tasks in the plurality of tasks have different durations.

12. The method of claim 10, wherein at least two tasks in the plurality of tasks have different priorities.

13. The method of claim 10, wherein at least one task in the plurality of tasks is associated with more than one queue.

14. The method of claim 10, wherein each job is implemented by one or more algorithms, and wherein media data is processed by executing the one or more algorithms that implement the jobs to be executed.

15. The method of claim 14, wherein each task is associated with a list of algorithms that may be executed for that task, and wherein allocating scratch memory for each of the tasks comprises:
determining a maximum scratch memory requirement for the algorithms that may be executed for that task; and
allocating locations in a memory to accommodate the maximum scratch memory requirement for the task.

16. The method of claim 14, wherein the instructions to add a job to a queue include instructions to allocate memory locations to accommodate the persistent memory requirements for the one or more algorithms that implement that job.

17. An apparatus comprising a computer-readable medium having stored thereon a first table that contains an entry for each of a plurality of states of a media processing service, wherein each entry includes a first set of instructions to initialize a state and a second set of instructions to process control data for a state.

18. The apparatus of claim 17, wherein the computer-readable medium also has stored thereon a third set of instructions to process state transitions for a plurality of media processing services based on control data, and wherein the state transitions for one of the media processing services are also based upon the contents of the first table.

19. The apparatus of claim 17, wherein the computer-readable medium also has stored thereon a fourth set of instructions to be executed by a processor as a plurality of tasks to process media data based on entries on a plurality of job queues, wherein the first set of instructions include instructions to add jobs to the job queues.

20. The apparatus of claim 19, wherein one of the job queues is stored in a second table, wherein the second table is associated with one of the tasks, and wherein the second table contains a list of algorithms that are associated with the second table.

21. The apparatus of claim 20, wherein the second table contains an execution interval for the task.

22. A system for providing a plurality of media processing services, the system comprising:
a processor;
a port coupled to the processor to receive control messages and media data for a plurality of media processing services; and
a computer-readable medium that stores a first set of instructions to be executed by the processor to process the control messages for each of the plurality of media processing services and a second set of instructions to be executed by the processor to process the media data in a separate execution environment than the first set of instructions.

23. The system of claim 22, wherein the first set of instructions include instructions to:
invoke a third set of instructions to initiate a new state for an instance of one of the media processing services;
invoke a fourth set of instructions to process control messages for an instance of the new state of the media processing service; and
determine if the state should be changed and, if so, change the state of the instance of the media processing service.

24. The system of claim 23, wherein the first set of instructions reads from a table that corresponds to a media processing service to determine the set of instructions to invoke to initiate a new state, and the set of instructions to process control messages for the new state.

25. The system of claim 24, wherein there is a table for each media processing service, and wherein each table has an entry for each of the states of the corresponding media processing service.

26. The system of claim 25, wherein the second set of instructions manages the processing of media data based on the contents of a plurality of job queues.

27. The system of claim 22, wherein the second set of instructions comprises instructions to allocate locations in a memory so that the locations are shared by a plurality of media processing services.

28. A method of providing a plurality of media processing services, the method comprising:
receiving control messages and media data for a plurality of media processing services;
processing the control messages by a processor for each of the plurality of media processing services as a generic state machine; and
processing the media data by the processor in a separate execution environment than the control messages are processed by the processor.

29. The method of claim 28, wherein processing the control messages comprises executing a same set of instructions for each of the media processing services.

30. The method of claim 29, wherein processing the control messages further comprises:
invoking a set of instructions to initiate a new state for one of the media processing services;
invoking a set of instructions to process control messages for the new state of the media processing service; and
determining if the state should be changed and, if so, change the state of the media processing service.

31. The method of claim 30, wherein the set of instructions to process the control messages reads from one of a plurality of tables to determine the set of instructions to invoke to initiate a new state and the set of instructions to process control messages for the new state, wherein each table corresponds to a different media processing service.

32. The method of claim 31, wherein each table has an entry for each of the states of the corresponding media processing service.

33. The method of claim 33, wherein processing the control messages includes adding jobs to one of a plurality of queues, and wherein processing of the media data is based upon the contents of said queues.

34. The method of claim 28, wherein the method further comprises allocating locations in a memory so that the locations are shared by a plurality of media processing services.

35. A system comprising:
a circuit board;
a processor coupled to the circuit board; and
a non-volatile computer-readable medium coupled to the circuit board and to the processor and having stored thereon a first set of instructions to be executed by the processor to control a plurality of media processing services as a plurality of state machines, wherein the same first set of instructions control the state machine for each the media processing services.

36. The system of claim 35, wherein the computer-readable medium also stores a plurality of tables each of which relates to the operation of one of the state machines, wherein each table comprises a plurality of entries, and wherein each of said entries corresponds to a state for one the media processing services.

37. The system of claim 36, wherein each of said entries includes a second set of instructions to initialize a state for one of the media processing services, and wherein each of said entries also includes a third set of instructions to process control messages for a state for one of the media processing services.

38. The system of claim 37, wherein the second set of instructions include instructions to add a job to one of a plurality of queues, and wherein the computer-readable medium also has stored thereon a fourth set of instructions to manage the processing of media data for the plurality of media processing services by causing the execution by the processor of jobs that are listed on said queues.

39. The system of claim 38, wherein the first set of instructions and the fourth set of instructions are to be executed by the processor in separate environments.

40. The system of claim 38, wherein the fourth set of instructions are to be executed by the processor as a plurality of tasks, and wherein each of said queues is associated with one of said tasks.

41. The system of claim 40, wherein each job is implemented by one or more algorithms, and wherein the fourth set of instructions allocate memory locations in a memory at the start of each of said tasks to accommodate the maximum scratch memory requirements for the algorithms that implement jobs associated with that task.
